(19) United States
(12) Patent Application Publication
(10) Pub. No.: US 2016/0313548 A1
(43) Pub. Date: Oct. 27, 2016

(54) METHOD FOR CAPTURING IMAGE OF THREE-DIMENSIONAL STRUCTURE OF SPECIMEN AND MICROSCOPIC DEVICE

(71) Applicant: OLYMPUS CORPORATION, Tokyo (JP)

(72) Inventor: Shintaro FUJII, Tokyo (JP)

(73) Assignee: OLYMPUS CORPORATION, Tokyo (JP)

(21) Appl. No.: 15/133,012

(22) Filed: Apr. 19, 2016

(30) Foreign Application Priority Data
Apr. 21, 2015 (JP) 2015-086919
Feb. 23, 2016 (JP) 2016-032050

(51) Int. Cl. G02B 21/36; G02B 21/18; G02B 21/16; H04N 13/02; H04N 5/225

(52) U.S. Cl. CPC G02B 21/367; H04N 13/0207; H04N 5/2256; G02B 21/16; G02B 21/18

(57) ABSTRACT

A structure of a specimen is labeled with a material whose state can be switched between a first state and a second state, wherein the material has fluorescence in the first state and does not have fluorescence in the second state when excited by light of a predetermined wavelength. The material in the first state is illuminated with the light and is excited. The excited material is imaged and images having a disparity are obtained. Positions of the material in an in-plane direction perpendicular to an optical axis are identified. A position of the material in a direction of the optical axis is identified by use of the positions of the material in the in-plane direction. Processing including from exciting the material to identifying a position of the material in the optical-axis direction is repeatedly performed so as to obtain a three-dimensional structure of the specimen.

### CROSS REFERENCE TO RELATED APPLICATIONS

This application is based upon and claims the benefit of priority from prior Japanese Patent Application No. 2015-086919, filed Apr. 21, 2015 and prior Japanese Patent Application No. 2016-032050, filed Feb. 23, 2016, the entire contents of which are incorporated herein by this reference.

### BACKGROUND OF THE INVENTION

1. Field of the Invention

The present invention relates to a method for capturing an image of a three-dimensional structure of a sample by super-resolution microscopy.

2. Description of the Related Art

It is known that super-resolution microscopy permits an achievement of a high resolution beyond the diffraction limit of visible light. In localization microscopy, which is one of the super-resolution microscopies, when a fluorescent material in the field of view is excited, fluorescence is emitted from the material at random. The fluorescence is imaged onto an imaging element multiple times by use of an imaging optical system, and information about a position of a bright spot in each image is obtained. Then, the information about a bright spot detected in each of the images is superimposed over one of the images, so as to obtain an image having a microstructure beyond a resolution limit of light.

Conventionally, there exists a technology for obtaining a three-dimensional image of a specimen by localization microscopy.

For example, “Three-Dimensional Super-Resolution Imaging by Stochastic Optical Reconstruction Microscopy”, Science, 2008 Feb. 8, Vol. 319 no. 5864 pp. 810-813, discloses a method that uses a cylindrical lens. In the method that uses a cylindrical lens, astigmatism caused by arranging a cylindrical lens on a light path is used. In other words, light from a specimen is changed, by the astigmatism, to have an ellipse shape, and the ellipticity varies according to the coordinate in a z-direction. Thus, the position in the z-direction, that is, depth information, is obtained by use of the ellipticity, and the depth information in the z-direction is added to an image in an xy-direction that is obtained by localization microscopy, so as to generate a three-dimensional image.

“Three-dimensional, single-molecule fluorescence imaging beyond the diffraction limit by using a double-helix point spread function”, PNAS, 2009 Jan. 9, Vol. 106 pp. 2995-2999, discloses a method that uses a double helix. In the method that uses a double helix, a phase modulation is performed so that a PSF (point spread function) is in a double helix shape. Thus, two spots appear on an image in an xy-plane with respect to a certain z, and a rotation angle of the two spots is dependent on the coordinate in the z-direction. Accordingly, depth information is obtained from a relationship between the rotation angle of the two spots and information about a position in the z-direction, that is, depth information, and the depth information in the z-direction is added to an image in the xy-direction that is obtained by localization microscopy, so as to generate a three-dimensional image.

### SUMMARY OF THE INVENTION

A method for capturing an image of a three-dimensional structure of a specimen according to an aspect of the present invention includes labeling a structure of the specimen with a material whose state can be switched between a first state and a second state, wherein the material has fluorescence in the first state and does not have fluorescence in the second state when excited by light of a predetermined wavelength, illuminating the material with the light of the predetermined wavelength by use of an illumination optical system and exciting at least a portion of materials in the first state, imaging the excited material by use of an imaging optical system, obtaining a plurality of images having a disparity that occurs when the excited material is imaged, identifying positions of the material in the plurality of images in an in-plane direction perpendicular to an optical axis in the specimen, identifying a position of the material in a direction of the optical axis in the specimen by use of the positions of the material in the plurality of images in the in-plane direction in the specimen, and further repeatedly performing processing in series so as to obtain a three-dimensional structure of the entirety of the specimen, the processing including exciting the material, imaging the excited material by use of the imaging optical system, obtaining the plurality of images, identifying a position of the material in an in-plane direction perpendicular to an optical axis in the specimen, and identifying a position of the material in the optical-axis direction in the specimen.

A microscopic device that captures an image of a three-dimensional structure of a specimen according to an aspect of the present invention includes a labeling unit that labels a structure of the specimen with a material whose state can be switched between a first state and a second state, wherein the material has fluorescence in the first state and does not have fluorescence in the second state when excited by light of a predetermined wavelength, an illumination optical system that illuminates the material with the light of the predetermined wavelength and excites at least a portion of materials in the first state, an imaging optical system that images the excited material, and an image processor that obtains a plurality of images having a disparity that occurs when the imaging is performed by the imaging optical system, identifies positions of the material in the plurality of images in an in-plane direction perpendicular to an optical axis in the specimen, identifies a position of the material in a direction of the optical axis in the specimen by use of the positions of the material in the plurality of images in the in-plane direction in the specimen, and further repeatedly performs processing in series so as to obtain a three-dimensional structure of the entirety of the specimen, the processing including exciting the material, imaging the excited material by use of the imaging optical system, obtaining the plurality of images, identifying a position of the material in an in-plane direction perpendicular to an optical axis in the specimen, and identifying a position of the material in the optical-axis direction in the specimen.

### BRIEF DESCRIPTION OF THE DRAWINGS

The present invention will be more apparent from the following detailed description when the accompanying drawings are referenced.

FIG. 1 illustrates a schematic configuration of a stereomicroscope equipped with a Galilean collimating optical system;

FIG. 2 is a diagram that explains a method for obtaining a three-dimensional super-resolution image;

FIG. 3 is a schematic configurative diagram of a TIRF microscopic device;

FIG. 4 is a schematic configurative diagram of a microscopic device when a polarizing plate is used;

FIG. 5 is a schematic configurative diagram of another microscopic device when the polarizing plate is used;

FIG. 6 is a flowchart that illustrates processing of capturing an image of a three-dimensional structure of a specimen performed by a microscopic device according to a first embodiment;

FIG. 7 is a schematic configurative diagram of a microscopic device according to a second embodiment;

FIG. 8 is another schematic configurative diagram of the microscopic device according to the second embodiment;

FIG. 9 is a schematic configurative diagram of the microscopic device according to the second embodiment to which light sheet illumination is applied;

FIG. 10 is a schematic configurative diagram of a microscopic device whose eccentric position is switchable;

FIG. 11 is a schematic configurative diagram of a microscopic device to which a method using disk scanning is applied;

FIG. 12 is a schematic configurative diagram of a microscopic device to which a light sheet illumination is applied; and

FIG. 13 is a flowchart that illustrates processing of capturing an image of a three-dimensional structure of a specimen performed by the microscopic device according to a third embodiment.

### DESCRIPTION OF THE EMBODIMENTS

In the method that generates a three-dimensional image by localization microscopy that uses a cylindrical lens or a double helix, it is not possible to obtain an xy-position of a bright spot by Gaussian fitting or a centroid detection, which is a difference from the usually used localization microscopy. In other words, calculation processing such as fitting for obtaining an xy-position of a bright spot will be complicated because the PSF shape varies according to the z-position. Further, in localization microscopy, many images are required if a density of a bright spot is low, which results in an increase in the time for image capturing. Thus, In order to reduce the time for image capturing, it is necessary to adjust experimental conditions such as labeling of a fluorescent material (that is, fluorescent labeling) so as to make a density of a bright spot high, with the result that the calculation processing such as fitting for obtaining the xy-position of a bright spot is complicated.

An object of the present invention is to provide a technology that makes it possible to easily capture an image of a three-dimensional structure of a specimen without complicating calculation processing. Further, another object is to provide a technology that makes it possible to easily capture an image of a three-dimensional structure of a specimen without complicating calculation processing even when a density of a bright spot is high.

Embodiments of the present invention will be described in detail below with reference to the drawings.

### First Embodiment

### Galilean Microscope

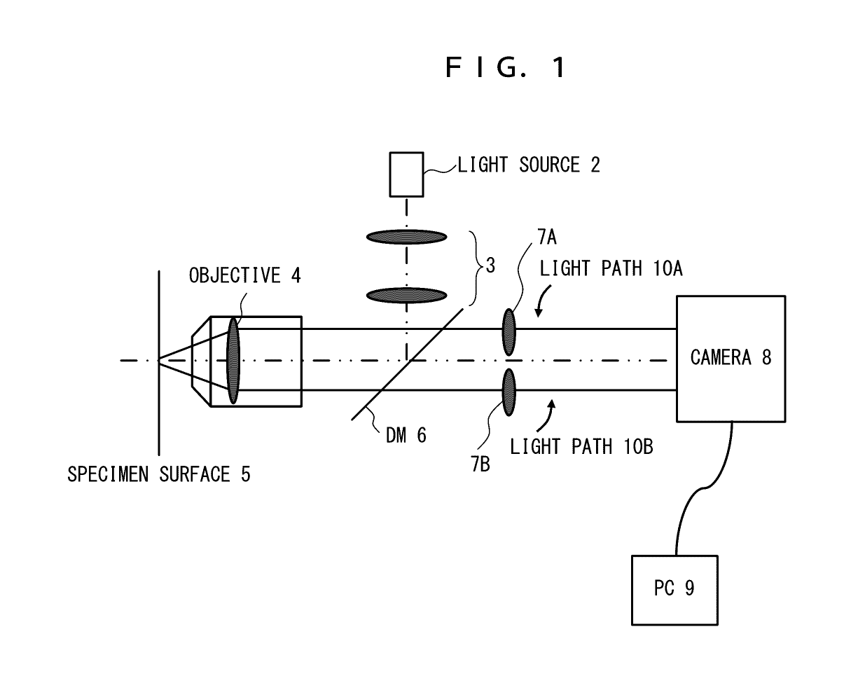

FIG. 1 is a schematic configurative diagram of a microscopic device according to the present embodiment. FIG. 1 illustrates a schematic configuration of a stereomicroscope equipped with a Galilean collimating optical system.

A structure of a specimen is labeled with a material whose state can be switched between a first state and a second state, wherein the material has fluorescence in the first state and does not have fluorescence in the second state at a predetermined wavelength.

Light of a predetermined wavelength is emitted from a light source 2. The light emitted from the light source 2 is irradiated onto a specimen surface 5 through an illumination optical system 3. Excitation light is reflected onto a dichroic mirror (DM) 6 and irradiated onto the specimen surface 5 through an objective 4. When the excitation light is irradiated, a portion of the materials with which the specimen is labeled, that is, materials in the first state, are excited. In this regard, the same applies to the microscopic devices that will be described below.

Fluorescence is emitted from the exited material and enters a camera 8 through both of two tube lenses 7A and 7B. The camera 8 is arranged in an imaging position of the tube lenses 7A and 7B. Accordingly, an image signal of the specimen is obtained by an imaging element of the camera 8, and the obtained image signal is transferred to an information processor of, for example, a personal computer (PC) 9. The PC 9 performs necessary processing on the image signal transferred from the camera 8, so as to obtain a super-resolution image of the specimen.

In other words, on the specimen surface 5, a fluorescent material is excited and shines at random, so if the camera 8 performs image capturing multiple times, an image with a bright spot that shines at each timing will be obtained. In the PC 9, pieces of information about positions of a bright spot corresponding to one another in a plurality of images in an XY-plane that are obtained in this way are superimposed over one another, so as to generate one image. This makes it possible to capture an image of a structure of a specimen at a high resolution beyond a resolution at a wavelength of light in a usually used microscopic device.

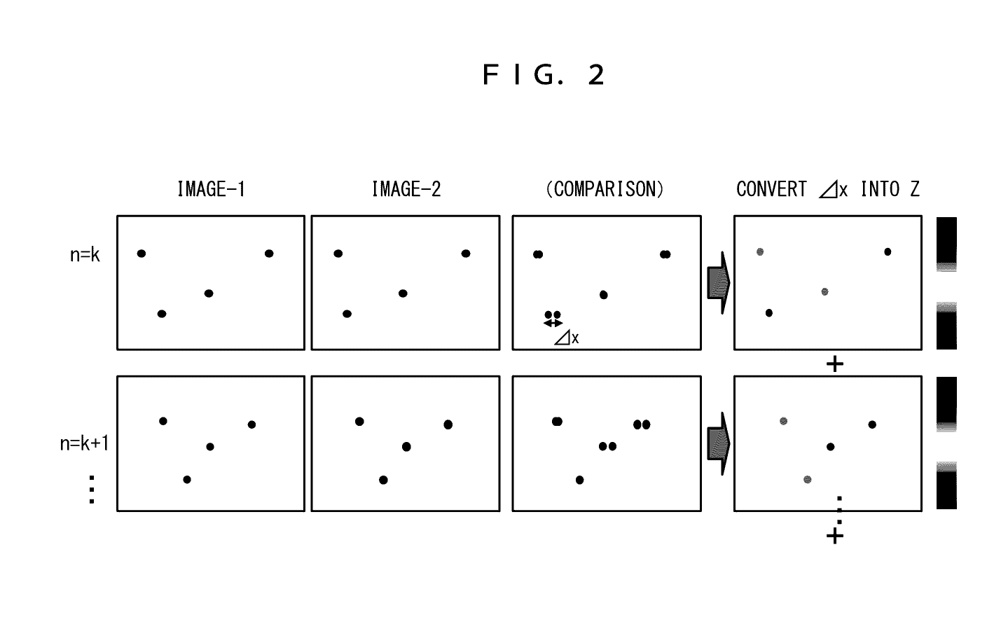

Here, the microscopic device illustrated in FIG. 1 is a stereomicroscope, and a disparity occurs between two light paths (light paths 10A and 10B) obtained by splitting light from the structure in the specimen. Thus, in the microscopic device according to the present embodiment, information about a position of a specimen in a z-direction, that is, information about a height of the specimen, is calculated by use of a disparity between two images (hereinafter referred to as a pair of images) that are obtained through the tube lenses 7A and 7B, respectively. This will be described with reference to FIG. 2.

FIG. 2 is a diagram that explains a method for obtaining a three-dimensional super-resolution image by use of the microscopic device according to the present embodiment.

A random emission of fluorescence from a material that is caused by excitation light can be used to obtain a structure of a specimen in an XY-direction at a high resolution. Calculation may be performed by use of a known multiple-emitter localization algorithm when structures in an X-direction and a Y-direction, that is, pieces of information about positions of a bright spot, are calculated. A Bayesian estimate and compressed sensing are examples of the multiple-emitter localization algorithm. As described above, the microscopic device according to the present embodiment permits calculating of information about a position of a specimen in a Z-direction by use of a disparity between an obtained pair of images. Further, the microscopic device according to the present embodiment adds the calculated information to the structure in the XY-direction obtained by, for example, applying a known algorithm, so as to obtain data of a three-dimensional super-resolution image of the specimen.

Specifically, a disparity Δx between a pair of images (images 1 and 2) obtained by image capturing at a timing of n=k is converted into information about a position in the Z-direction, and the obtained information is considered to be information about a height of a bright spot whose image is captured at n=k. In the example illustrated in FIG. 2, information about a height in the Z-direction is represented according to the scale.

In FIG. 2, for a simple explanation, a disparity Δx for one bright spot in a pair of images obtained at a timing of n=k is described. Actually, a disparity is obtained for each bright spot and converted into information about a position in the Z-direction, so as to obtain information about a height of each of the bright spots in the images.

Likewise, for a pair of images captured and obtained at the next timing of n=k+1, a disparity is converted into information about a position in the Z-direction so as to obtain information about a height of a bright spot in the pair of images obtained at n=k+1.

As described above, as is the case with conventional super-resolution microscopy, image capturing is performed multiple times and one image is generated by superimposing, over one another, pieces of information about positions in the X-, Y-, and Z-directions that are obtained at a capturing timing n, so as to obtain a three-dimensional-shaped high-resolution image of a specimen.

According to conventional localization microscopy, calculation processing for obtaining pieces of information about positions in the X-, Y-, and Z-directions has been greatly complicated when obtaining a three-dimensional-shaped high-resolution image. However, according to the present embodiment, information about a position in the Z-direction is obtained from each pair of images having a disparity, and processing of combining the obtained information with pieces of information about positions in the X- and Y-directions is performed as is conventionally performed, the pieces of information about positions in the X- and Y-directions being obtained by image capturing multiple times. This permits image capturing of a three-dimensional structure of an entire specimen at a high resolution. In other words, it is possible to easily generate a three-dimensional high-resolution image without complicating the calculation processing.

A case in which experimental conditions are adjusted to make the density of a bright spot greater in order to shorten the time for image capturing by reducing the number of captured images by localization microscopy will be described below.

An algorithm for accurately obtaining a position of each bright spot is known in, for example, “Simultaneous multiple-emitter fitting for single molecule super-resolution imaging”, Biomedical Optics Express, 2011 May 1, Vol. 2 pp. 1377-1393. The algorithm that can also correspond to the case in which a plurality of bright spots are included in an analytical area is called a multiple-emitter localization algorithm. When this algorithm is applied, a position of each bright spot can be detected even in a state in which the bright spots are not sufficiently separated from one another. Thus, it is possible to obtain positions of multiple bright spots in a single image capturing, which permits a decrease in a total number of image capturings required for obtaining a super-resolution image. A Bayesian estimate and compressed sensing are examples of the multiple-emitter localization algorithm.

When pieces of information about positions in the X-direction and in the Y-direction are calculated by use of the above-described multiple-emitter localization algorithm, a bright spot can be detected with a great density. This permits a shortening of the time for capturing a super-resolution image. In addition to this, information about a position in the Z-direction is calculated from a disparity between a pair of images and the obtained information is used in combination with the pieces of information about positions in the X-direction and in the Y-direction that are obtained by use of the multiple-emitter localization algorithm, which results in obtaining a three-dimensional structure of a specimen by performing a simple calculation while shortening the time for image capturing with a great density.

An existing method such as the PALM, the STORM, the dSTORM, or self-blinking can be used as the mechanism described above that fluoresces at random. A state in which the density of a bright spot is great refers to a state in which at least a portion of the materials capable of emitting fluorescence (the first state) are excited at a distance between the nearest material in the first state and imaging within a spatial resolution.

The Galilean microscope of FIG. 1 has been described above as an example. On the other hand, a method for generating a three-dimensional super-resolution image by localization microscopy according to the present embodiment may also be realized by other types of microscopic devices. This will be specifically described below.

### (TIRF (Total Internal Reflection Fluorescence) Microscope)

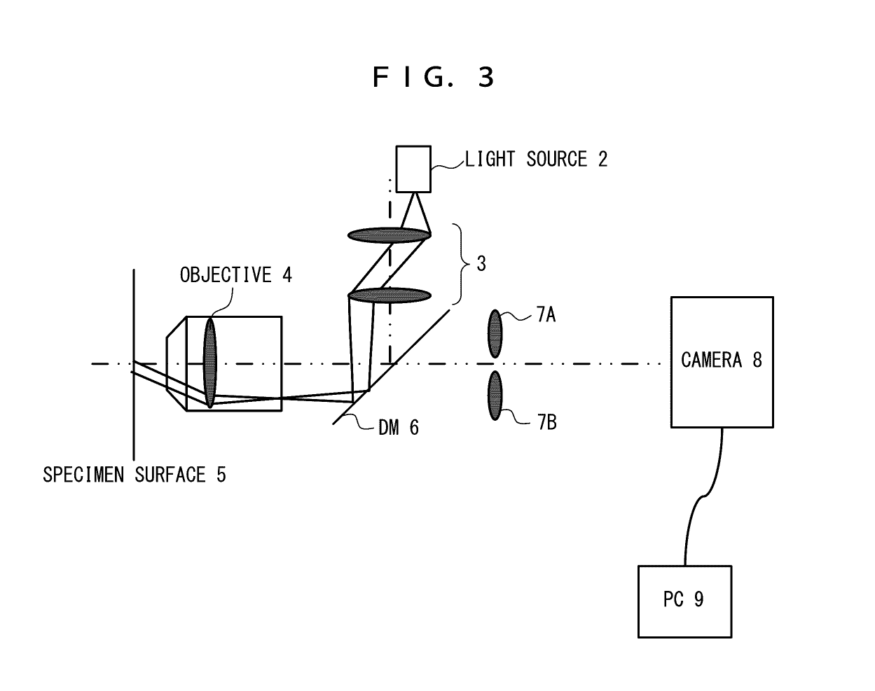

FIG. 3 is a schematic configurative diagram of a TIRF microscopic device.

In a TIRF microscope, light emitted from the light source 2 is excited through the illumination optical system 3. The excitation light is collected in a position that deviates from an optical axis of a rear focal plane (pupil plane) of the objective 4 through the DM 6 and is irradiated onto the specimen surface 5. Here, an arrangement is made such that total internal reflection is given on the specimen surface 5. In the TIRF microscope, there exists a disparity between two images obtained by capturing, with an imaging element of the camera 8, images of pieces of light that are transmitted through the respective tube lenses 7A and 7B. This permits a pair of images having a disparity to be obtained in the PC 9, as is the case with the Galilean microscope of FIG. 1.

Information about a height of each bright spot is obtained by converting a disparity Δx for each of the bright spots into information about a position in the Z-direction, and likewise, pieces of information about heights are obtained for a plurality of pairs of images, which permits obtaining of a three-dimensional super-resolution image of a specimen. The method is similar to that of the above-described Galilean microscope and has been described with reference to FIG. 2.

In the TIRF microscope, only the materials located near the specimen surface 5 are excited because only a limited range is illuminated with respect to an optical-axis direction of imaging. Thus, when a specimen is in a thick shape in which it has, in the Z-direction, a thickness equal to or greater than a predetermined thickness, a TIRF microscope that is able to suppress background light coming from outside a focal plane is preferably used.

### (Method Using Polarizing Plate)

In addition to using the Galilean microscope of FIG. 1 and the TIRF microscope of FIG. 3, it is also possible to obtain a three-dimensional-shaped image by obtaining images having a disparity by use of the configuration of an optical system of a microscope.

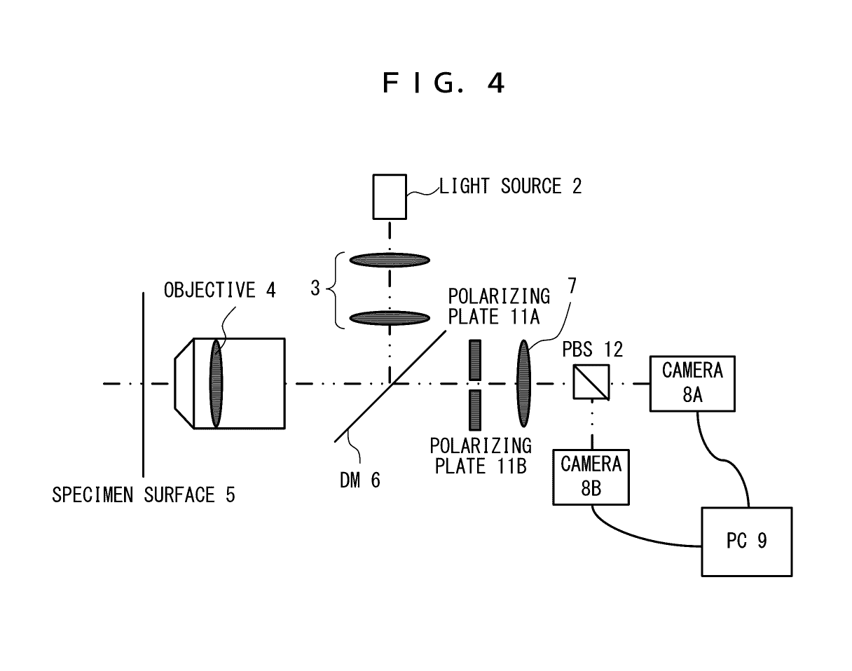

FIG. 4 is a schematic configurative diagram of a microscopic device when a polarizing plate is used. As illustrated in the light path diagram of FIG. 4, when excitation light obtained by exciting, by use of the illumination optical system 3, light emitted from the light source 2 is irradiated onto the specimen surface 5, fluorescence is emitted from the specimen surface 5. The fluorescence is transmitted through the DM 6, and only light that is polarized in a predetermined direction is transmitted through a polarizing plate 11A or 11B. In the example, only s-polarized light is transmitted through the polarizing plate 11A of FIG. 4 that is one of the polarizing plates, and only p-polarized light is transmitted through the polarizing plate 11B that is the other polarizing plate. Accordingly, pieces of light obtained by separating the light for each polarization component by use of a polarization beam splitter (PBS) 12 enter two cameras 8A and 8B, respectively. The camera 8A and 8B capture an image of light of an s-polarization component and an image of light of a p-polarization component, respectively, and vice versa. The PC 9 generates an image of the s-polarization component or the p-polarization component using an image signal transferred from the camera 8A or 8B. In the example, the camera 8A captures the image of light of an s-polarization component and the camera 8B captures the image of light of a p-polarization component. The PC 9 generates images of the s-polarization component and the p-polarization component using image signals transferred from the cameras 8A and 8B, respectively.

Here, there exists a disparity between the images of the s-polarization component and the p-polarization component because their corresponding pieces of light are respectively transmitted through different pupil positions and the images are formed with these pieces of light. Thus, the microscopic device having the configuration of FIG. 4 also permits obtaining of a three-dimensional super-resolution image of a specimen by the method of FIG. 2 described above, by using a disparity that occurs in the process of image formation and by obtaining a plurality of pairs of images.

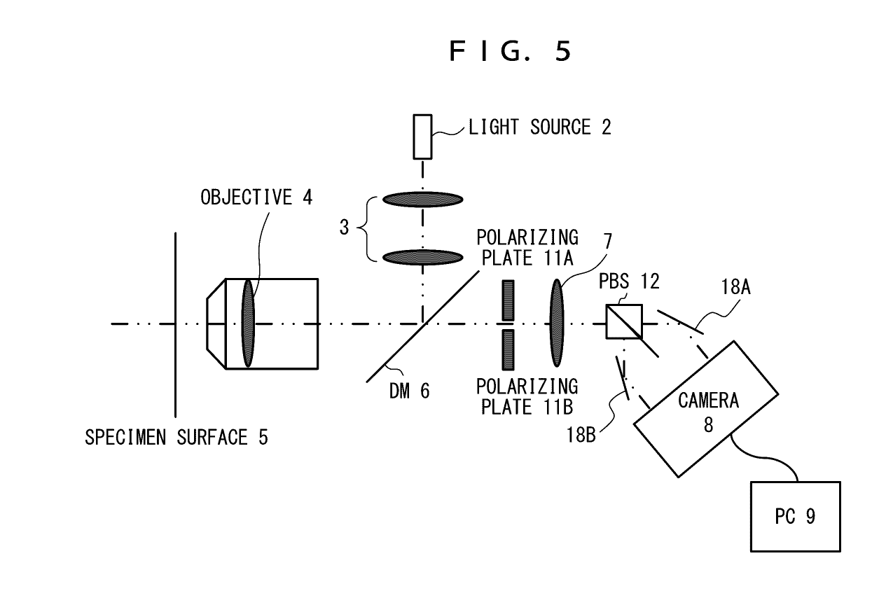

FIG. 5 is a schematic configurative diagram of another microscopic device when the polarizing plate is used. A microscope device illustrated in FIG. 5 is different from that of FIG. 4 in capturing images of two polarization components of p-polarized light and s-polarized light using a single camera 8.

As is the case with the microscope having the configuration of FIG. 4, light of an s-polarization component that has been transmitted through the polarizing plate 11A and light of a p-polarization component that has been transmitted through the polarizing plate 11B are separated by the PBS 12, are respectively reflected onto a mirror 18A and a mirror 18B, and enter the single camera 8. The camera 8 of FIG. 5 is able to capture, at the same time, a pair of images of the s-polarization component and the p-polarization component that have a disparity. Thus, as is the case with the microscope having the configuration of FIG. 4, it is possible to generate a three-dimensional super-resolution image of a specimen by the method of FIG. 2 described above, by obtaining a plurality of pairs of images.

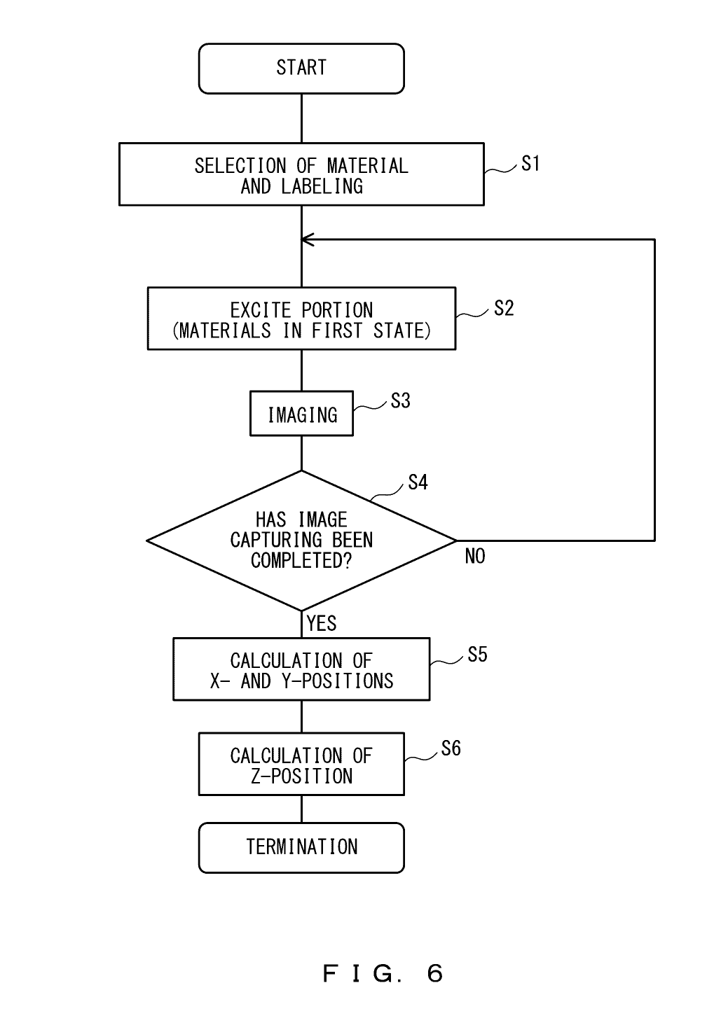

FIG. 6 is a flowchart that illustrates processing of capturing an image of a three-dimensional structure of a specimen performed by a microscopic device according to the present embodiment. FIG. 6 illustrates an operational flow until the above-described microscopic device configured to obtain a pair of images having a disparity at the same time obtains data of a three-dimensional super-resolution image of an entire specimen.

First, in Step S1, a material used for observation is selected, and a structure of a specimen is labeled with the selected material. In Step S2, a portion of materials, that is, those in a first state, are excited. In Step S3, using the tube lens 7, fluorescence emitted from the excited material is imaged onto an imaging element of the camera 8. This permits obtaining of a pair of images having a disparity. In Step S4, the excitation process of Step S2 and the imaging process of Step S3 are repeated multiple times until it is determined that image capturing has been completed. When it is determined that the image capturing has been completed, the process moves on to Step S5.

In Step S5, pieces of information about positions of a bright spot in the X-direction and in the Y-direction in each of the images are calculated. Then, in Step S6, for each pair of images, a disparity is obtained from the pieces of information about positions in the X-direction and in the Y-direction that are obtained in Step S5, and thereby information about a position in the Z-direction is calculated. Here, when the pieces of information about positions in the X-, Y-, and Z-directions are obtained, the processing is terminated.

In FIG. 6, first, a plurality of pairs of images are obtained in the processes of Step S2 to Step S4, and then, pieces of information about positions of a bright spot in the X-, Y-, and Z-directions in each of the pairs of images are obtained in Step S5 and Step S6, but the processing is not limited to this. For example, image data of a three-dimensional structure of an entire specimen may be obtained by obtaining, every time a pair of images is obtained, pieces of information about positions of a bright spot in the X-, Y-, and Z-directions in the obtained pair of images and by repeating this operation.

As was already described in the description of FIG. 2, the processing in series illustrated in FIG. 6 permits obtaining of pieces of information about positions of a bright spot in the X-, Y-, and Z-directions in a plurality of pairs of images without requiring a complicated calculation, but rather using a simple calculation. This results in obtaining a three-dimensional structure of an entire specimen at a high resolution. In other words, this permits obtaining of a three-dimensional super-resolution image of a specimen.

### Second Embodiment

### Realization of Long Focus Depth

As already described, according to the first embodiment above, measurement by the stereo method is applied to localization microscopy and a pair of images having a disparity is used, so as to capture an image of a three-dimensional structure at a high resolution. A microscopic device according to the present embodiment is different from that of the first embodiment in further including means for increasing a focus depth. This will be specifically described with reference to the drawings.

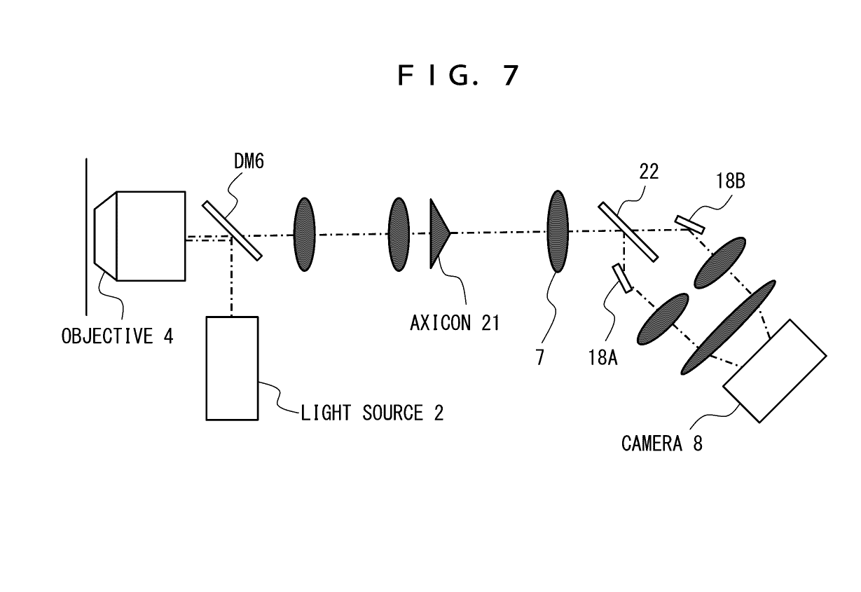

FIG. 7 is a schematic configurative diagram of a microscopic device according to the present embodiment.

The configuration of the microscopic device according to the present embodiment is different from that of the microscopic device according to the first embodiment in that an axicon lens 21 is arranged in an imaging optical system. A focal depth increases if the axicon lens 21 is arranged in the imaging optical system.

In localization microscopy that is one of the super-resolution microscopies, blurred light has a larger impact (the blurring increases) with distance from a focal position with respect to the Z-direction, which results in reducing localization accuracy. On the other hand, as illustrated in FIG. 7, the arrangement of the axicon lens 21 in the imaging optical system permits a microscopic device to acquire a long focal depth. In other words, the arrangement of the axicon lens 21 results in changing the shape of the PSF of the microscopic device to a shape that extends in the Z-direction. This permits avoiding of a reduction in local accuracy due to a blurred image and permits obtaining of a super-resolution image in the Z-direction even if the specimen is thick.

In this case, a performance degradation due to blurred light and a resolution in the Z-direction have a trade-off relationship, so the resolution in the Z-direction is reduced if a long focal depth is realized. However, according to the present embodiment, measurement by the stereo method is performed in combination with localization microscopy. This provides the advantage of independently obtaining a suppression of blurred light caused by an increase in focal depth and a super-resolution image in the Z-direction, in addition to not requiring a complicated calculation and being applicable to a known multiemitter-analysis, as is the case with the first embodiment.

In the configurative diagram illustrated in FIG. 7, a light split for obtaining a pair of images having a disparity is performed after a long focal depth is realized by the axicon lens 21. Light in which an increase in a focal depth of imaging is induced by the axicon lens 21 is split by a beam splitter 22, and pieces of light obtained by the split are directed by, for example, the mirrors 18A and 18B, and enter the camera 8. However, the timing of splitting light is not limited to this, and the light split may be performed before a long focal depth is realized.

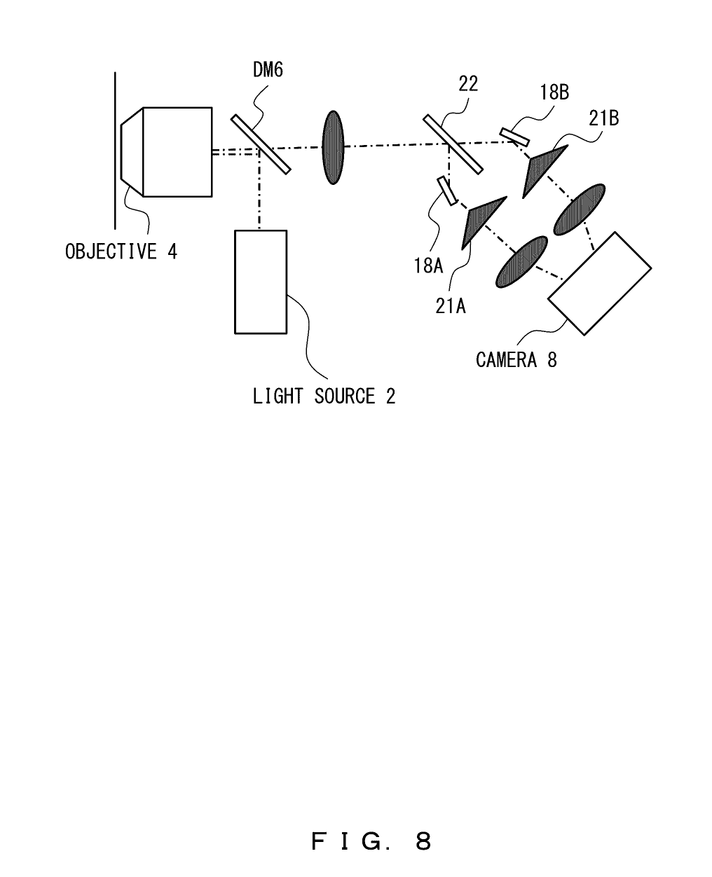

FIG. 8 is another schematic configurative diagram of the microscopic device according to the present embodiment. In the configuration illustrated in FIG. 8, axicon lenses 21A and 21B are respectively arranged on individual light paths obtained by splitting the light into two by use of the beam splitter 22.

As illustrated in FIG. 8, even when light from a specimen is split by the beam splitter 22 and focal depths of pieces of light obtained by the light split are increased by the axicon lenses 21A and 21B, respectively, it is possible to provide the same advantage as that of the configuration of FIG. 7 in which a long focal depth is realized before the light split.

In the first embodiment above, the microscopic devices that include various illumination optical systems have been described. On the other hand, in the microscopic device according to the present embodiment, the axicon lens 21 is arranged in an imaging optical system. Thus, a method for realizing a long focal depth by arranging the axicon lens 21 in an imaging optical system as in the present embodiment is applicable to the various microscopic devices listed in the first embodiment.

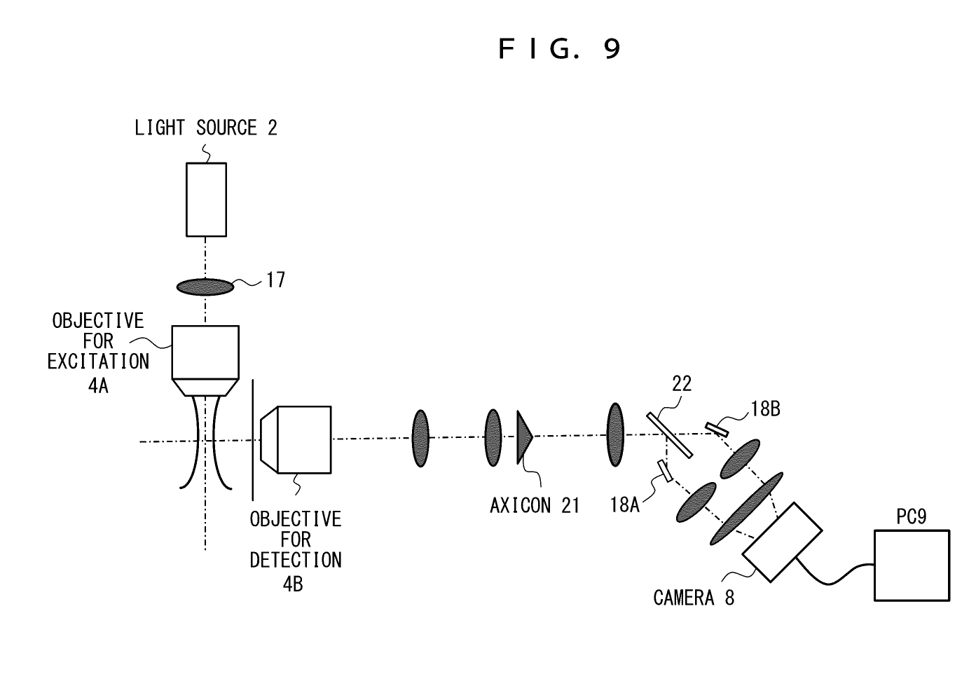

Further, if a microscopic device in which measurement by the stereo method is applied to localization microscopy is further configured such that a focal depth is increased, it is possible to, for example, lower the level required for a sectioning resolution of a sectioning microscope, compared to the conventional case. This will be described with reference to FIG. 9.

FIG. 9 is a schematic configurative diagram of the microscopic device according to the present embodiment to which a light sheet illumination is applied.

A specific configuration of the microscopic device to which a light sheet illumination is applied and its function will also be described in a third embodiment that will be described later. When a light sheet illumination is applied, light excited by an objective for excitation 4A is illuminated on a specimen and an objective for detection 4B detects fluorescence. A laser beam is expanded in a sheet shape by the objective for excitation 4A and illuminated onto the specimen from its side (from the upper direction in FIG. 9). The plane of this is imaged with the microscopic device from above (from the rightward direction in FIG. 9), and the specimen is moved in the Z-direction (in the up-and-down direction in FIG. 9), which also permits an observation of a thick specimen.

In such a microscopic device to which a light sheet illumination is applied, when the axicon lens 21 is arranged in an imaging optical system as illustrated in FIG. 9, accuracy degradation in an image due to an impact of blurred light is less likely to occur due to a realization of a long focal depth. In other words, the background light of an image is suppressed, which permits even a thick specimen to be observed. Thus, it is possible to lower the sectioning capability required for a sectioning microscope such as a microscopic device to which a light sheet illumination is applied, compared to the case without the axicon lens 21.

In addition, the axicon lens 21 is also arranged in an imaging optical system in a microscope in which any combination of the TIRF described above (see FIG. 3), a temporal focus optical system, and a HILO (highly inclined and laminated optical sheet) is used, which permits enjoying of the advantage provided by realizing a long focal depth.

### Third Embodiment

According to the first embodiment above, the microscopic device captures a pair of images having a disparity at the same time. On the other hand, a microscopic device of the present embodiment is different from that of the first embodiment in obtaining a pair of images by image capturing multiple times. The microscopic device according to the present embodiment may also have various configurations, as is the case with the first embodiment above. This will be specifically described below with reference to the drawings.

### (Method Using Eccentric Opening Switching)

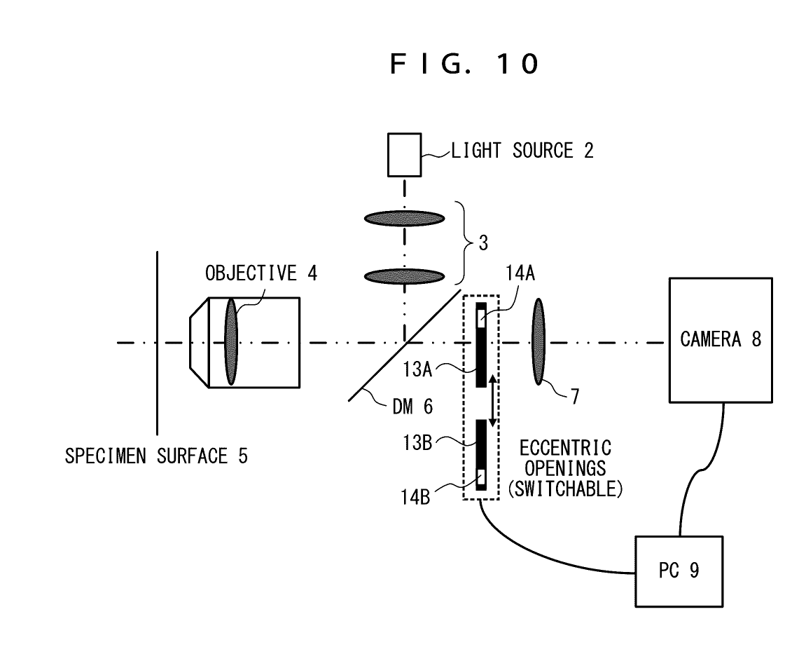

FIG. 10 is a schematic configurative diagram of a microscopic device whose eccentric position is switchable.

Light emitted from the light source 2 is irradiated by the illumination optical system 3 onto the specimen surface 5. Excitation light is irradiated onto the specimen surface 5. Fluorescence emitted from a material excited by the excitation light is transmitted through the DM 6 and transmitted through an eccentric opening 14A of a member 13A or an eccentric opening 14B of a member 13B, and its image is captured by the camera 8.

The members 13A and 13B are respectively provided with the eccentric openings 14A and 14B, on the upper side and the lower side with respect to an optical axis in FIG. 10. The PC 9 switches between the two members 13A and 13B arranged on a light path. The members are respectively provided with the eccentric openings 14A and 14B and transmit a beam in different pupil positions. The transmitted light is imaged in the tube lens 7 and enters the camera. The imaging element of the camera 8 images the pieces of light that are respectively transmitted through the eccentric openings 14A and 14B of the members 13A and 13B.

The inclusion of such a configuration permits obtaining of a pair of images having a disparity, as is the case with the microscopic device of FIG. 4 that is configured to include the two polarizing plates 11A and 11B. In this case, it is preferable to capture two images having a disparity at the same time, as is the case with the first embodiment, in terms of, for example, an accuracy of detecting a bright spot. However, when an interval of capturing the two images is about a few milliseconds, it is possible to obtain a pair of images with a relatively high accuracy. Thus, even according to the microscopic device having the configuration of FIG. 10, it is possible to easily obtain a three-dimensional high-resolution image without complicating calculation processing by obtaining a plurality of pairs of images by image capturing to obtain information about a position in the Z-direction of each bright spot from a disparity, as is the case with the first embodiment above.

### (Method Using Disk Scanning)

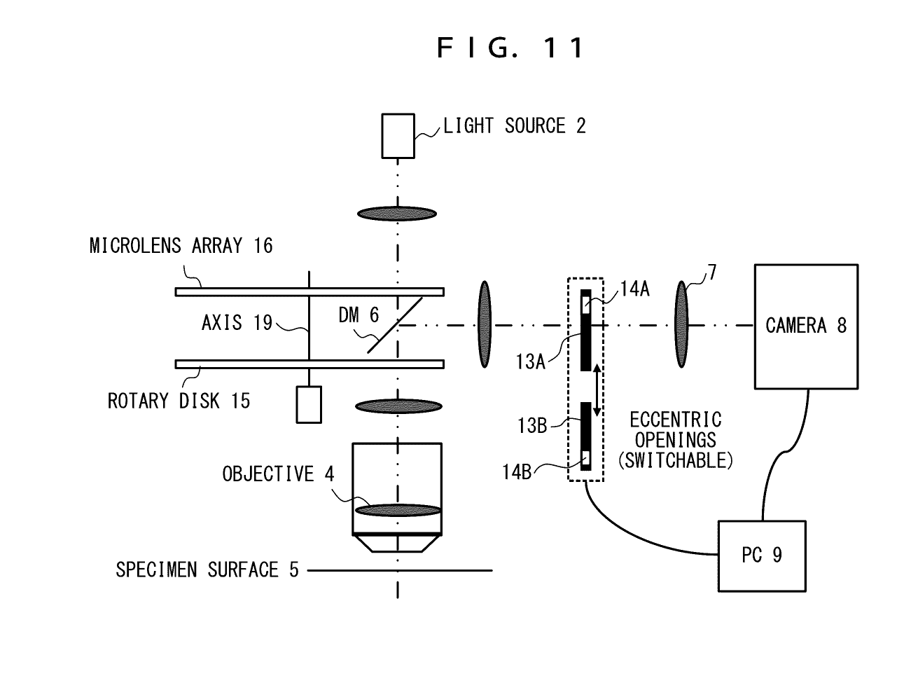

FIG. 11 is a schematic configurative diagram of a microscopic device to which a method using disk scanning is further applied in addition to the configuration of FIG. 10.

Light emitted from the light source 2 enters the objective 4 through a microlens array 16 and a rotary disk 15. Multiple pin holes are spirally arranged in the rotary disk 15. Also, microlenses are spirally arranged in the microlens array 16 such that they are paired with the respective pin holes of the rotary disk 15, which results in collecting the light emitted from the light source 2 in the pin holes.

When the rotary disk 15 (and the microlens array 16) is rotated about an axis 19, pieces of light that have passed through the multiple pin holes are sequentially irradiated onto the specimen surface 5 through the objective 4. This provides the same advantage as when the specimen surface 5 is scanned, which permits the camera 8 to capture an image at high speed.

As illustrated, also in the configuration of FIG. 11, the members 13A and 13B having the respective eccentric openings 14A and 14B are provided on a light path, as is the case with FIG. 10. Image capturing is performed by switching, according to the control of the PC 9, the members 13A and 13B arranged on the light path, which permits obtaining of a pair of images having a disparity because the members 13A and 13B transmit a beam in different pupil positions, as is the case with the microscopic device of FIG. 10. Thus, even the microscopic device to which a method using disk scanning is applied permits providing of the same advantage as that provided by the microscopic device of FIG. 10.

However, the method using disk scanning only permits imaging within a limited range with respect to the optical-axis direction. Thus, a microscope to which a method using disk scanning is applied is preferably used when a specimen has a thickness not less than a predetermined thickness in the Z-direction.

FIG. 11 illustrates the microscopic device to which a method using disk scanning is applied in addition to the configuration of FIG. 10, but the configuration is not limited to this. For example, the method using disk scanning may be applied to the microscopic device according to the first embodiment.

### (Light Sheet Illumination)

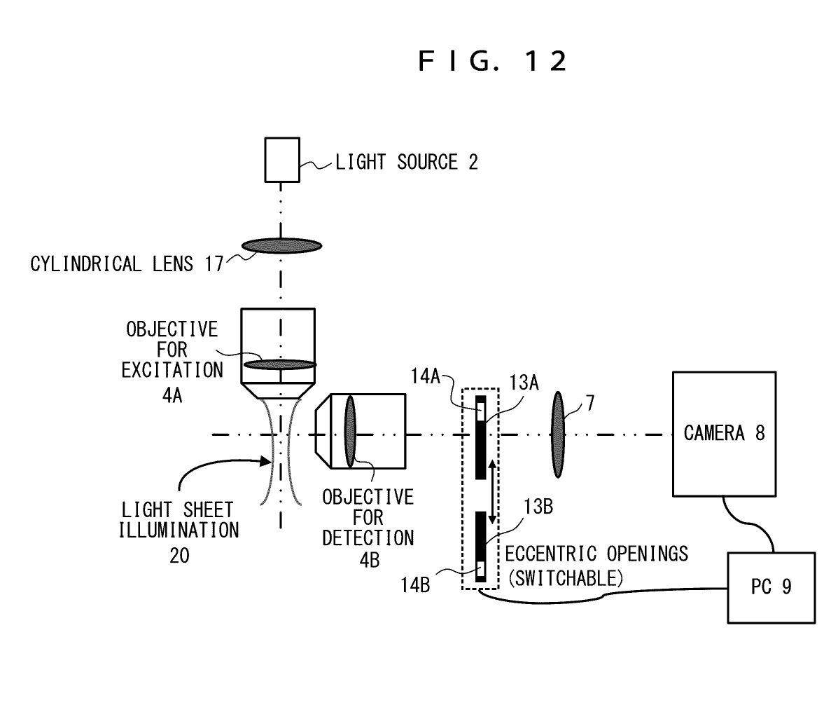

FIG. 12 is a schematic configurative diagram of a microscopic device to which a light sheet illumination is further applied in addition to the configuration of FIG. 10.

In the microscopic devices that have been described so far, the objective 4 irradiates excitation light and detects fluorescence. On the other hand, when a light sheet illumination 20 is applied, the objective for excitation 4A irradiates excitation light. The objective for detection 4B that is arranged perpendicularly to the objective for excitation detects fluorescence. A cylindrical lens 17 of FIG. 12 is provided for focusing an excitation light beam and illuminating on a specimen surface (that is omitted in FIG. 12) in a sheet shape.

Even the microscopic device to which the light sheet illumination 20 is applied permits obtaining of a pair of images having a disparity by switching the opening plates 13A and 13B to obtain images from components that are transmitted through the eccentric openings 14A and 14B of the respective opening plates 13A and 13B, as is the case with the microscopic device having the configuration illustrated in FIG. 10 or 11. When the light sheet illumination 20 is used, sheet shaped excitation light is irradiated onto a specimen, which permits generating of a three-dimensional super-resolution image of the specimen while reducing specimen damage.

The light sheet illumination 20 only permits an illumination within a limited range with respect to a direction of an optical axis of imaging, so only a material situated near the specimen surface 5 is exited. Thus, when the specimen has a thin shape having a thickness not less than a predetermined thickness in the Z-direction, a microscope to which a light sheet illumination 20 is applied is preferably used.

FIG. 12 illustrates the microscopic device to which a light sheet illumination 20 is applied in addition to the configuration of FIG. 10, but the configuration is not limited to this. For example, the light sheet illumination 20 may be applied to the microscopic device according to the first embodiment.

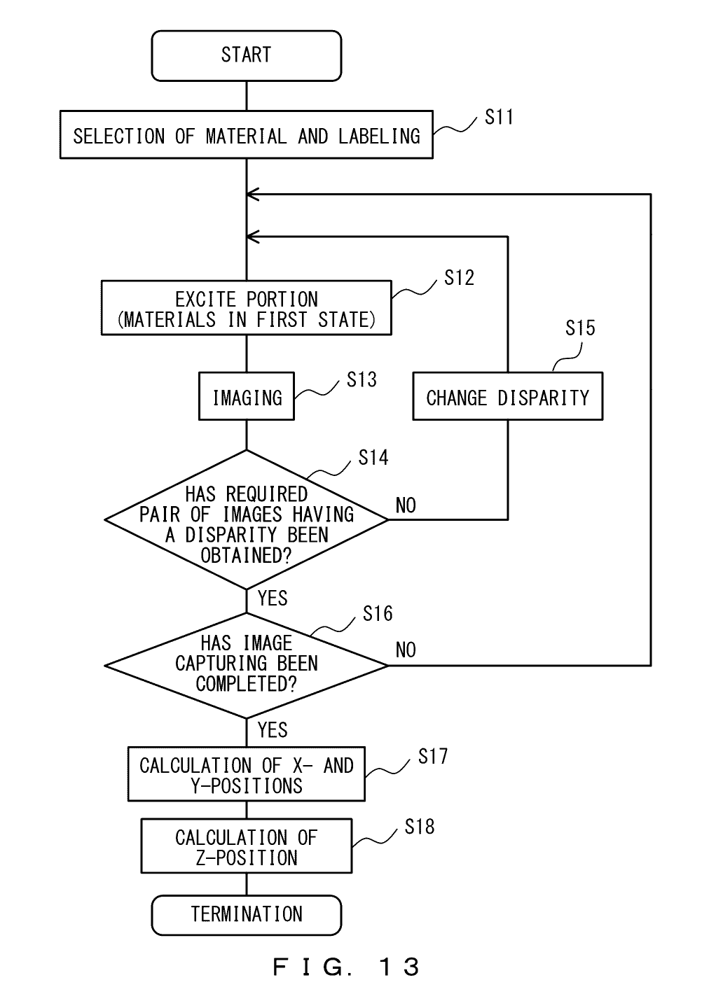

FIG. 13 is a flowchart that illustrates processing of capturing an image of a three-dimensional structure of a specimen performed by the microscopic device according to the present embodiment. FIG. 13 illustrates an operational flow until the above-described microscopic device configured to obtain a pair of images having a disparity by image capturing multiple times obtains data of a three-dimensional super-resolution image of an entire specimen.

In relation to FIG. 6, which illustrates an operational flow of the above-described microscopic device according to the first embodiment, the processes of Step S11 to Step S13 are similar to the processes of Step S1 to Step S3 of FIG. 6, respectively.

In Step S14, it is determined whether a pair of images having a disparity that is required for a calculation of information about a position in the Z-direction has been obtained. This can be determined on the basis of whether a switching control has been performed between the members 13A and 13B in the PC 9. When the images have not been obtained (No in Step S14), the process moves on to Step S15. In Step S15, a control for giving a disparity to images, that is, a control for switching the member 13A and the member 13B that are arranged on a light path is performed, and the process returns to Step S12. When the pair of images has been obtained (Yes in Step S14), the process moves on to Step S16.

The processes of and after Step S16 are similar to those of and after Step S4 of FIG. 6.

The processing in series illustrated in FIG. 13, too, permits providing of the same advantage as the case of FIG. 6 in which a pair of images is obtained at the same time.

Also in FIG. 13, as is the case with FIG. 6, for example, image data of a three-dimensional structure of an entire specimen may be obtained by obtaining, every time a pair of images is obtained, pieces of information about positions of a bright spot in the X-, Y-, and Z-directions in the obtained pair of images, and by repeating this operation.

The present invention is not limited to the above-described embodiments as they are, but may be embodied by deforming constituents within a scope not deviating from the gist of the invention at an execution step. In addition, various inventions can be made by appropriately combining a plurality of constituents that have been disclosed in the above embodiments. For example, all the constituents that have been disclosed in the embodiments may be appropriately combined. Further, constituents in different embodiments may be appropriately combined. It should be understood that various modifications and applications can be made without departing from the scope and the spirit of the invention.

What is claimed is:

1. A method for capturing an image of a three-dimensional structure of a specimen comprising:
labeling a structure of the specimen with a material whose state can be switched between a first state and a second state, wherein the material has fluorescence in the first state and does not have fluorescence in the second state when excited by light of a predetermined wavelength;
illuminating the material with the light of the predetermined wavelength by use of an illumination optical system and exciting at least a portion of materials in the first state;
imaging the excited material by use of an imaging optical system;
obtaining a plurality of images having a disparity that occurs when the excited material is imaged,
identifying positions of the material in the plurality of images in an in-plane direction perpendicular to an optical axis in the specimen;
identifying a position of the material in a direction of the optical axis in the specimen by use of the positions of the material in the plurality of images in the in-plane direction in the specimen; and
further repeatedly performing processing in series so as to obtain a three-dimensional structure of the entirety of the specimen, the processing including exciting the material, imaging the excited material by use of the imaging optical system, obtaining the plurality of images, identifying a position of the material in an in-plane direction perpendicular to an optical axis in the specimen, and identifying a position of the material in the optical-axis direction in the specimen.

2. The method for capturing an image of a three-dimensional structure according to claim 1, wherein an increase in a focal depth of imaging is induced when the excited material is imaged.

3. The method for capturing an image of a three-dimensional structure according to claim 2, wherein an increase in the focal depth of the imaging is induced by generating a Bessel beam by use of an axicon lens.

4. The method for capturing an image of a three-dimensional structure according to claim 1, wherein a plurality of images having a disparity are obtained at the same time by splitting light from the specimen and using pieces of light obtained by the split when the plurality of images are obtained.

5. The method for capturing an image of a three-dimensional structure according to claim 4, wherein an increase in a focal depth of imaging is induced before light from the specimen is split.

6. The method for capturing an image of a three-dimensional structure according to claim 4, wherein an increase in a focal depth of imaging is induced after light from the specimen is split.

7. The method for capturing an image of a three-dimensional structure according to claim 1, wherein the illumination optical system has a limited thickness in a direction of an optical axis of imaging and an illumination is performed within a limited range with respect to a direction of an optical axis of the illumination optical system.

8. The method for capturing an image of a three-dimensional structure according to claim 1, wherein at least a portion of materials in the first state are excited at a distance between the nearest material in the first state and the imaging within a spatial resolution.

9. The method for capturing an image of a three-dimensional structure according to claim 1, wherein the position in the in-plane direction is identified by applying a multiple-emitter localization algorithm to perform analysis.

10. The method for capturing an image of a three-dimensional structure according to claim 1, wherein the imaging optical system performs imaging within a limited range in an optical-axis direction.

11. A microscopic device that captures an image of a three-dimensional structure of a specimen comprising:
a labeling unit that labels a structure of the specimen with a material whose state can be switched between a first state and a second state, wherein the material has fluorescence in the first state and does not have fluorescence in the second state when excited by light of a predetermined wavelength;
an illumination optical system that illuminates the material with the light of the predetermined wavelength and excites at least a portion of materials in the first state;
an imaging optical system that images the excited material; and
an imaging processor that
obtains a plurality of images having a disparity that occurs when the imaging is performed by the imaging optical system,
identifies positions of the material in the plurality of images in an in-plane direction perpendicular to an optical axis in the specimen,
identifies a position of the material in a direction of the optical axis in the specimen by use of the positions of the material in the plurality of images in the in-plane direction in the specimen, and
further repeatedly performs processing in series so as to obtain a three-dimensional structure of the entirety of the specimen, the processing including exciting the material, imaging the excited material by use of the imaging optical system, obtaining the plurality of images, identifying a position of the material in an in-plane direction perpendicular to an optical axis in the specimen, and identifying a position of the material in the optical-axis direction in the specimen.
